(19) United States
(12) Patent Application Publication
(10) Pub. No.: US 2008/0090520 A1
(43) Pub. Date: Apr. 17, 2008

(54) APPARATUS AND METHODS FOR COMMUNICATION MOBILITY MANAGEMENT USING NEAR-FIELD COMMUNICATIONS

(76) Inventors: William O. Camp, Chapel Hill, NC (US); Philip Marc Johnson, Raleigh, NC (US)

Correspondence Address: MYERS BIGEL SIBLEY & SAJOVEC, P.A., P.O. BOX 37428, RALEIGH, NC, 27627, US

(21) Appl. No.: 11/550,169

(22) Filed: Oct. 17, 2006

(51) Int. Cl. H04B 7/00; H04M 1/00

(52) U.S. Cl. 455/41.2; 455/552.1

(57) ABSTRACT

A system for managing mobile communications includes a dual-mode mobile terminal that has a first mobile transceiver configured to perform near-field communication operations and a second mobile transceiver configured to perform short-range communication operations. The system also includes a first network transceiver in a local-area-network (LAN) configured to transmit access data to the first mobile transceiver using near-field communication operations and a second network transceiver in the LAN configured to communicate, using short-range communication operations, with the second mobile transceiver, based on the access data.

### BACKGROUND

The present invention relates to the field of electronic devices in general and, more particularly, to mobile communication terminals.

Mobile communication terminals, such as cellular telephones, are increasingly being equipped with more varied and robust features. For example, in addition to some long-range communication capabilities, such as cellular communication, some mobile terminals are configured to provide other communication options. Such communication options include short-range communication with other networks, such as local-area-networks, using wired and/or wireless access points. For example, mobile terminals can access network resources using WiFi, which is a short-range communication standard defined under IEEE 802. In addition to accessing local proximity based resources, mobile terminals that include short-range communication functionality may provide certain advantages over long-range communication systems in terms of both signal quality and cost of service.

Dual-mode mobile terminals having both long-range and short-range communication capabilities, however, provide basic mobility management challenges for selecting which of the communication modes to use. One approach is to enable both modes continuously and switch to the short-range communication mode when an appropriate communication link can be established. In this manner, a dual-mode mobile terminal may constantly scan for available short-range network resources. Whenever short-range communication signals are detected, the mobile terminal can register with the network providing the short-range coverage and access the resources made available by the network. Such continuous scanning for short-range network coverage can consume additional power that can diminish the life of a terminal battery. For example, a mobile terminal that might otherwise realize a battery life of several hundred hours of standby time, may be reduced to a fraction of that time if a short-range communication transceiver is continuously energized for scanning. An alternative to continuously scanning is to manually enable a short-range communication function when a user is aware of being within short-range network coverage area. Manual activation, however, may be considered cumbersome and thus undesirable to a user.

### SUMMARY

Embodiments of the present invention provide apparatus and methods for managing mobile communications in a mobile terminal. Methods of some embodiments provide that access data can be communicated from a local area network (LAN) to the mobile terminal through a near-field-communication (NFC) link or similar and that a short-range communication link from the mobile terminal can be initiated in response to the receipt of the access data by the mobile terminal. Embodiments can further transmit routing data responsive to the short-range communication link, from the mobile terminal to a telecommunication network to cause the telecommunication network to route communications through the short-range communication link. In some embodiments, transmitting routing data can include sending routing data through the short-range communication link and/or sending the routing data using the near-field communication operation. In yet other embodiments, transmitting routing data can include sending the routing data to a cellular network through a cellular communication link.

In further embodiments, communicating access data can include receiving a network address of a short-range network device into the mobile terminal.

In yet further embodiments, initiating a short-range communication link can include powering-on a short-range transceiver in the mobile terminal. In some embodiments, initiating a short-range communication link can include powering-on a WIFI compatible transceiver in the mobile terminal. In further embodiments, initiating a short-range communication link can include transmitting access payment information from the mobile terminal through the short-range communication link or through the NFC link to a LAN operator to obtain further access to the short-range communication link. In yet further embodiments, initiating a short-range communication link can include transmitting access payment information from the mobile terminal through the near-field-communication link to a LAN operator to obtain access to the short-range communication link.

Embodiments of systems for managing mobile communications can include a first network transceiver in a local-area-network (LAN) configured to transmit access data through a close-range communication link and a dual-mode mobile terminal that can include a first mobile transceiver configured to receive the access data through the close-range communication link and a second mobile transceiver configured to communicate LAN access data through a short-range communication link in response to the receipt of the access data. Embodiments of such systems can also include a second network transceiver in the LAN configured to receive the LAN access data through the short-range communication link from the second mobile transceiver.

In some embodiments, the first network transceiver can be further configured to receive mobile terminal data from the first mobile transceiver and send the mobile terminal data to a communications network and the close-range communication link is a near-field-communication link.

In further embodiments, the mobile terminal can further include a third mobile transceiver configured to communicate with a telecommunication network through a remote transceiver.

In yet further embodiments, the second network transceiver and the second mobile transceiver can be configured to communicate data responsive to the telecommunication network.

In some embodiments, the mobile terminal can be a client of the LAN and the access data can be authentication data, wherein the first mobile transceiver receives location data from the first network transceiver over the close-range communication link, and wherein the communication network is configured to allocate network resources responsive to the location data.

Yet other embodiments can include updating means for providing updated access data when a subsequent near-field communication operation occurs at a third network transceiver in the LAN.

In some embodiments, methods of managing mobile communications for a multiple mode mobile terminal can include enabling short-range wireless communication between the mobile terminal and a network in response to near-field signals received by the mobile terminal from a near-field-communication transmitter.

In further embodiments, enabling short-range wireless communication can include receiving access data corresponding to the network into the mobile terminal from the near-field-communication transmitter. In yet further embodiments, the access data can include an Internet Protocol (IP) address of an access point in the network.

In yet further embodiments, enabling short-range wireless communication can include sending incoming call routing data from the mobile terminal to a communications system routing device responsive to cause communications to the mobile terminal to be routed using a short-range wireless communication link between the network and the mobile terminal. In some embodiments, sending incoming call routing data can include communicating via a cellular communication transceiver in the mobile terminal.

In some embodiments, enabling short-range wireless communication can include powering-on a short-range wireless communication circuit in the mobile terminal.

Some embodiments can also include sending payment information from the mobile terminal to the network.

Yet further embodiments can include using cellular communication to transmit a routing identifier to a communication system responsive to cause communications to the mobile terminal to be rerouted through the short-range wireless communication link.

In some embodiments, the short-range wireless communication data can be updated when a subsequent near-field communication provides a different short-range wireless communication access point.

In further embodiments, a short-range wireless communication circuit can be disabled responsive to receipt of a near-field termination signal.

In yet further embodiments, a short range wireless communication circuit can be disabled responsive to a loss of the short-range communication link.

In some embodiments, mobile terminal data can be sent to the communication network via a network near-field communication device.

In some other embodiments, a mobile client can be authenticated responsive to the near-field signals. In some embodiments, a location of the mobile client can be determined using the near-field signals and a network resource can be assigned to the mobile client based on the location.

In some embodiments, a mobile communication device can include a close-range communications transceiver configured to receive a close-range communication signal from a network and a short-range wireless communications transceiver configured to be enabled to communicate with the network responsive to the received close-range communication signals.

In some embodiments, the close-range communications transceiver comprises a signal receiver configured to receive the close-range communication signal via magnetic induction.

In further embodiments, the close-range communication signal comprises a near-field-communication signal.

In yet further embodiments, the close-range communication signal comprises close-range communication access data corresponding to the network.

In some embodiments, payment data is transferred from the mobile terminal to the network.

In some other embodiments, the close-range communications transceiver is configured to receive a disable signal from the network and the short-range wireless communications transceiver is disabled responsive to the disable signal.

In yet other embodiments, the device can include a cellular transceiver configured to change enablement states responsive to the close-range communication signal.

### BRIEF DESCRIPTION OF THE DRAWINGS

FIG. 1 is a block diagram illustrating systems/methods for managing mobile communications in a mobile terminal in accordance with some embodiments of the present invention.

FIG. 2 is a block diagram illustrating systems/methods for managing mobile communications in a mobile terminal in accordance with the systems/method of FIG. 1, further including additional network components.

FIG. 3 is a block diagram illustrating systems/methods for managing mobile communications in a mobile terminal in accordance with yet other embodiments of the present invention.

FIG. 4 is a block diagram illustrating systems/methods for managing mobile communications in a mobile terminal as applied to a private network in accordance with yet further embodiments of the present invention.

FIG. 5 is a flow diagram illustrating operations for managing mobile communications in a mobile terminal in accordance with some embodiments of the invention.

FIG. 6 is a flow diagram illustrating operations for managing mobile communications in a mobile terminal in accordance with some other embodiments of the invention.

FIG. 7 is a flow diagram illustrating operations for managing mobile communications in a mobile terminal in accordance with further embodiments of the invention.

FIG. 8 is a flow diagram illustrating operations for managing mobile communications in a mobile terminal in accordance with yet further embodiments of the invention.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Some embodiments and examples herein are presented using near-field-communication (NFC) as an interface supporting close-range communication. NFC, as defined by the NFC forum and standards ISO/IEC 14443, uses a low-frequency 13.56 MHz carrier and magnetic coupling to transfer data. NFC can be operative in a variety of modes. In one NFC mode, one device may remain passive. In this mode, the passive device (e.g. NFC tag) is powered by the magnetic field induced by the other device (e.g. reader/writer). An NFC device operating in passive mode within a portable device has significant advantages in terms of power savings since the NFC transceiver uses no power in its standby mode. Low frequency communication, such as defined above, can be typically limited in range to a few inches. This can be considered an advantage in many contexts as there is an inherent security associated with the close range.

Although NFC close-range communication methods are presented in significant detail, other close range technologies can be used within the scope and spirit of this invention. For example, low-power radio frequency (RF) communications and/or infrared communications can be used. The power advantages of NFC over the alternate technologies, however, render NFC as an ideal non-limiting example of close-range communication in the context herein.

Some embodiments of the invention nay arise from the recognition that where a mobile terminal includes a short-range receiver, determining when a short-range communication function should be enabled can be cumbersome and/or can consume power thereby reducing battery life of the mobile terminal. Accordingly, some embodiments use near-field-communication (NFC) to enable a short-range communication link. A mobile terminal can be configured to include a mobile NFC transceiver and a mobile short-range communication transceiver. A network can include a network NFC transceiver configured to provide access data to the mobile NFC transceiver. The network can further include a network short-range transceiver configured to communicate with the mobile short-range transceiver using the access data provided through the NFC. In this manner, the mobile short-range function is enabled using access data received from the network through the NFC.

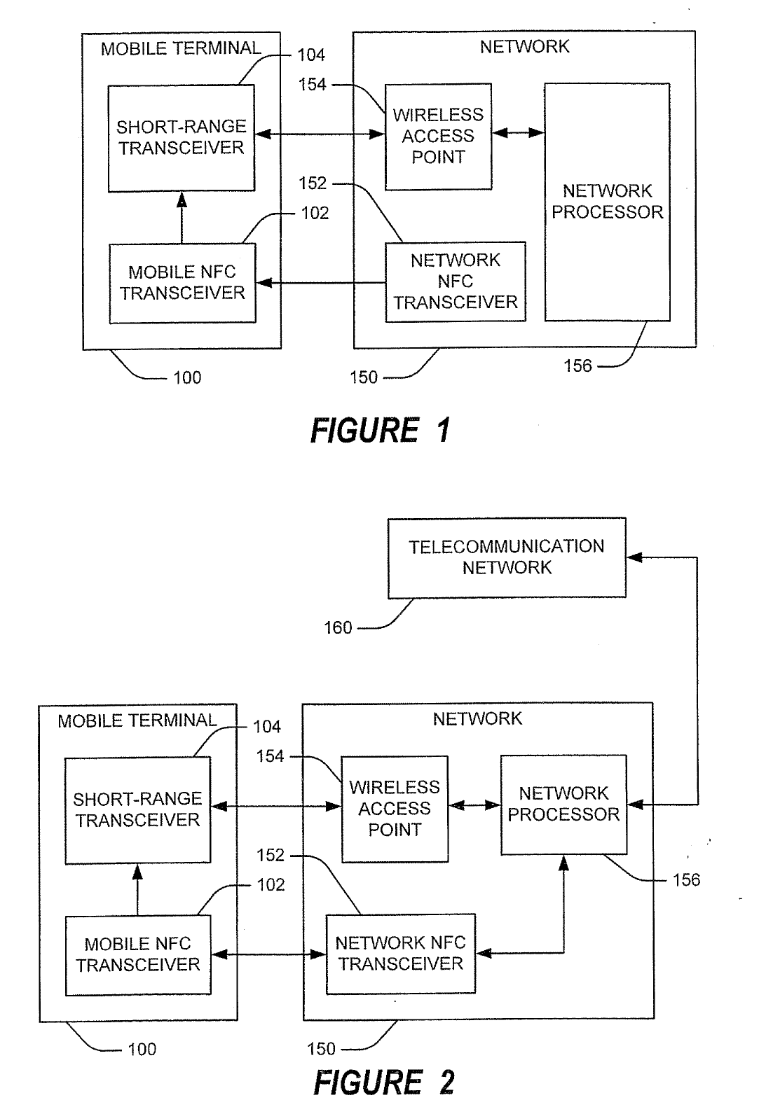

Systems and methods according to some embodiments of the present invention will now be described with reference to the block diagram of FIG. 1. As shown in the embodiments of FIG. 1, a mobile terminal 100 can include a mobile near-field-communication (NFC) transceiver 102 that can wirelessly communicate with another NFC transceiver when the two transceivers are in very close proximity, such as within several inches of one another. For example, a user entering a wireless communication “hot spot” that includes short-range wireless coverage can simply swipe the mobile terminal 100 near a network NFC transceiver 152 upon entering the premises or coverage zone. The mobile terminal 100 can be, for example, a cellular telephone, PDA, mobile computing device, and/or another type of mobile communication device. The mobile terminal 100 can also include a mobile short-range transceiver 104 configured to wirelessly communicate with a network wireless access point 154 in a network 150. The network wireless access point 154 can include any of a variety of short-range transceivers that can be configured to communicate using any of a variety of communication protocols. One non-limiting example of a protocol is WiFi as defined under IEEE 802 and related standards.

The network 150 can be a public network provided for the use of visitors, customers, employees, and/or clients. The network 150 of some embodiments may be a private network configured to be accessed by and/or to serve specific system clients, such as employees, for example. In some embodiments, the network 150 may include connections to a local-area-network (LAN) and/or a wide-area-network (WAN).

The network NFC transceiver 152 can be configured to exchange data with the mobile NFC transceiver 102 and to transmit access data to the mobile NFC transceiver 102 in response to that data exchange. In some embodiments, the network NFC transceiver 152 may be a stand-alone device that is communicatively isolated from other components of the network 150 and/or may unidirectionally communicate data to the mobile NFC transceiver 102. The access data can be used by the short-range transceiver 104 to establish a short-range communication link to the network 150 through a wireless access point 154.

The access data is received by the mobile NFC transceiver 102 and sent to the mobile short-range transceiver 104. The access data can include information that identifies an identity of the wireless access point 154, its availability, and conditions/terms of the availability. The conditions/terms of availability identified by the access data may include cost information to allow a mobile terminal user to purchase access to the network 150. The access data information may identify a network address such as, an internet protocol (IP) address and/or a media access control (MAC) address to be used by the mobile short-range transceiver 104 to establish communications with the wireless access point 154. In some further embodiments, the access data information can include authentication and/or validation data for a user to access a private network through the wireless access point 154.

In some embodiments, the mobile short-range transceiver 104 can be activated (e.g. powered on) in response to receiving access data through the mobile NFC transceiver 102. Accordingly, the access data can be used by the mobile short-range transceiver 104 to activate, detect, communicate with, and/or log onto the network 150 through the wireless access point 154. In this manner, the mobile terminal 100 can minimize power consumption until triggered by the access data to utilize the resources provided through the network 150, and related components, peripherals, and/or systems.

Reference is now made to FIG. 2, which is a block diagram illustrating further systems/methods for managing mobile communications in a mobile terminal in accordance with some embodiments of the invention. The mobile NFC transceiver 102 can send routing data regarding a routing server to the network NFC transceiver 152. The routing data can be transmitted to the network processor 156, which can then send related routing and/or rerouting data to a telecommunication network 160. The telecommunication network 160 may include the Public Switched Telephone Network (PSTN) and associated central offices and/or may include a cellular communication network and associated mobile switching offices. The routing and/or rerouting data can be used to inform the telecommunication network 160 and/or associated components, such as a mobile switching office, to route any defined communications, such as incoming telephone calls and/or data transmissions, which are directed to the mobile terminal 100 through the network 150 to the mobile terminal 100 via the short-range transceiver 104.

In some embodiments, the network NFC transceiver 152 can transmit other information to the network processor 156, such as mobile terminal identification information, user account information, and/or payment information. In some embodiments, the routing data and/or other information can be transmitted from the mobile terminal 100 to the network 150 via the mobile short-range transceiver 104 and the wireless access point 154.

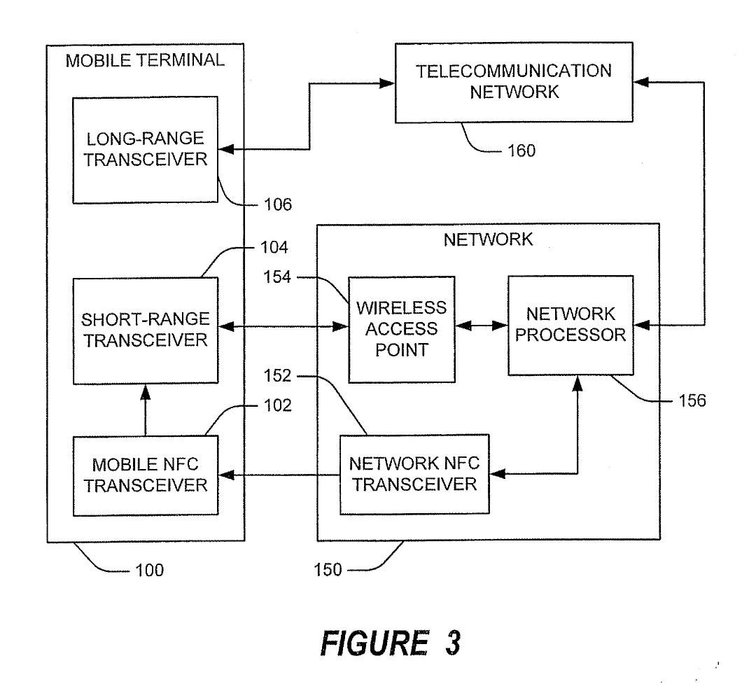

Methods/systems for managing mobile communications in a mobile terminal according to some embodiments of the present invention will now be described with reference to the block diagram of FIG. 3. The mobile terminal 100 includes the mobile NFC transceiver 102 and further includes a long-range transceiver 106, configured to provide long range communications with other communication devices associated with the telecommunication network 160. The long-range transceiver 160 can be, for example, a cellular transceiver. In some embodiments, the long-range transceiver 106 can respond to data received from the wireless access point 154 and/or the network NFC transceiver 152, by transmitting routing and/or rerouting data to the telecommunication network 160 and/or a third party routing server (not shown) for directing and routing the incoming communications to the mobile terminal 100.

The routing data can be used by the telecommunication network 160 to route and/or reroute communications, such as telephone calls and/or data transmissions, to the mobile terminal 100 through the wireless access point 154 and the short-range receiver 104. In this manner, the mobile terminal 100 can take advantage of potential cost and/or signal quality benefits that may be available compared to using the long-range transceiver 106. In the case of a private network, the rerouting of incoming and outgoing communications to and from the mobile terminal may result in preferential service properties such as pricing, quality of service, etc. For example, a user may have an NFC transceiver in a residential setting that reroutes communications through a home network when the user is at home.

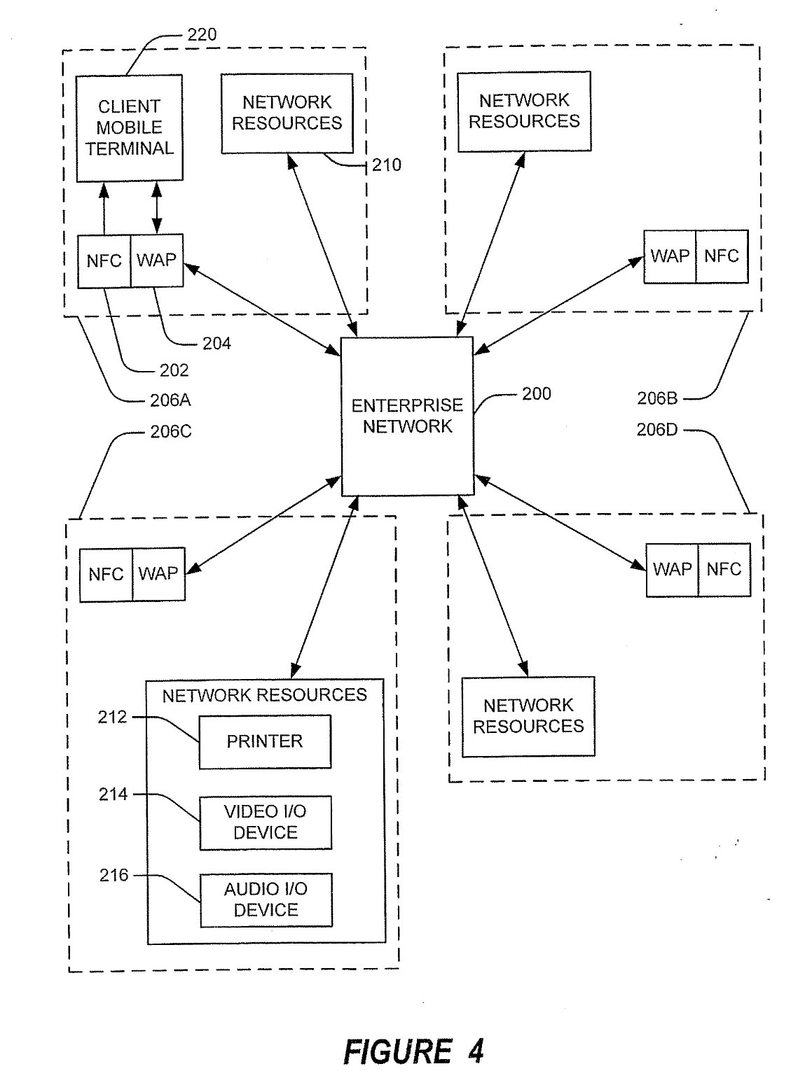

Reference is now made to FIG. 4, which is a block diagram illustrating systems/methods in accordance with some embodiments of the invention. An enterprise network 200 can include peripheral devices configured to create one or more coverage zones 206A-D. For example, coverage zone 206A may be accessed by a client mobile terminal 220 using an NFC device 202 to activate a communication link between the client mobile terminal 220 and a wireless access point (WAP). The NFC device 202 can transmit data to the client mobile terminal 220 that enables and/or activates a short-range communication circuit in the client mobile terminal 220. The data can also include access rights data that enables the client mobile terminal 220 to access the enterprise network 200 through the WAP 204. Based on the NFC operation and/or the short-range communication, the enterprise network 200 can allocate and/or assign specific network resources 210 to operations by the client mobile terminal 220. Examples of network resources 210 that can be allocated for use in client mobile terminal operations include, for example, a printer 212, a video input/output device 214, and/or an audio input/output device 216.

In use and operation of the some embodiments herein, a user may swipe a client mobile terminal 220 in close proximity to a NFC device 202 in a coverage area 206. The client mobile terminal 220 can access the enterprise network 200 via the WAP 204 in that coverage zone 206. The network resources 210 in that coverage area can be allocated for any client mobile terminal 220 operations that occur while the user is in that specific coverage zone 206. If the user moves to another coverage zone 206, the communications with the enterprise network 200 can be continued and/or resumed using a different WAP 204 and different network resources 210 can be allocated.

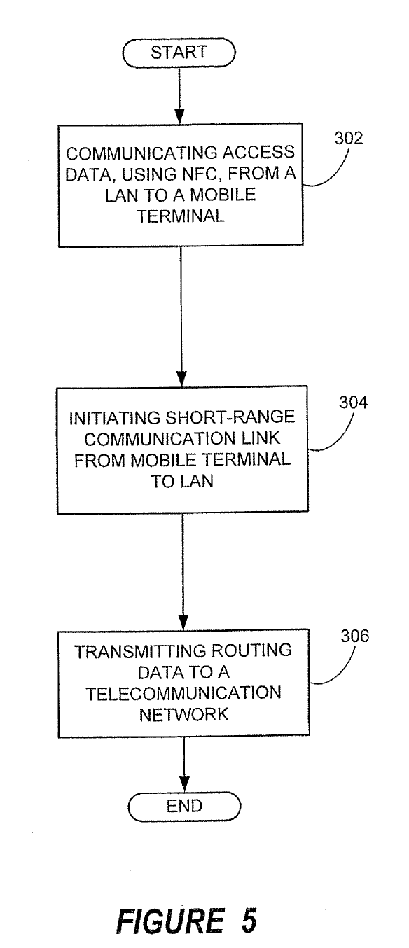

Reference is now made to FIG. 5, which is a flow diagram illustrating embodiments of operations in accordance with the invention. Access data can be exchanged using NFC between a mobile terminal and a LAN (block 302). Access data can include network address information, such as an IP and/or a MAC address of the mobile terminal, a LAN device, and/or another communication network device. Access data can also include internet service provider (ISP) data that can be used to route and/or reroute communications to the mobile terminal through the LAN. The access data can further include payment and/or other types of account information regarding usage of the LAN or its resources. The LAN can be a computer and/or communication network that is publicly available or is restricted to private use and/or access by authorized clients only.

Using the access data, a short-range communication link is initiated between the mobile terminal and the LAN (block 304). The short-range communication link can be used by the mobile terminal to access the LAN and/or other resources connected to and/or by the LAN. For example, the short-range communication link can be used by the mobile terminal to access the internet or other external resources linked to the LAN. The short-range communication link can also be used to transmit routing and/or rerouting data for incoming communications to the mobile terminal. The routing data can be transmitted to a telecommunication network (block 306). For example, if the mobile terminal includes a cellular telephone, the rerouting data can be used to direct incoming calls through the LAN via the short-range communication link instead of using the long-range transceiver that can be typical of cellular communications. Additionally, the short-range communication link can be used to exchange authentication information, account information, and/or payment information between the mobile terminal and the LAN.

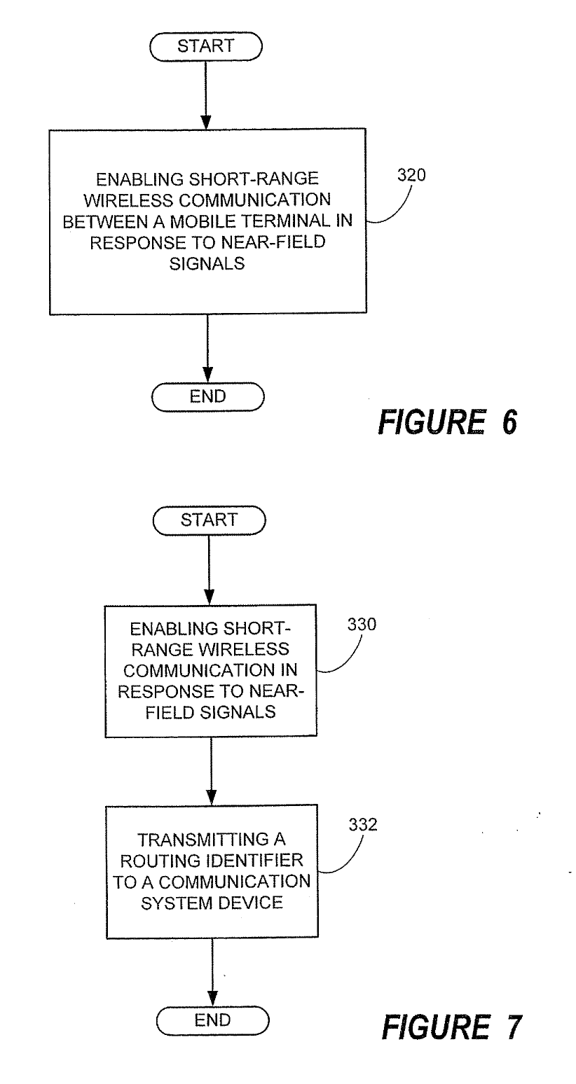

Reference is now made to FIG. 6, which is a flow diagram illustrating some other embodiments of operations in accordance with the invention. A short-range wireless communication link is enabled between a mobile terminal and a communication network using near-field signals (block 320). The near-field signals can be the result of an NFC operation, which can be used by a mobile terminal user to enable short-range communication with a network by placing the mobile terminal in close proximity with a network NFC transceiver that includes access data for the network. Close proximity in some embodiments can be within a range of five feet. The network NFC transceiver can optionally be in communication with the network and can be used to receive data from the mobile terminal. Received data can include third party service provider information, account information, payment information and/or routing information.

Reference is now made to FIG. 7, which is a flow diagram illustrating yet other embodiments of operations in accordance with the invention. Short-range wireless communication between a mobile terminal and a network is enabled in response to near-field signals (block 330). A routing identifier is transmitted to a communication system device (block 332). The routing identifier can include data corresponding to a telecommunication service provider, a routing server, and/or a variety of network addresses that can be used to route incoming communications to the mobile terminal through the network via short-range communication. Rerouted communications can include telephone calls and/or data transmissions such as email and/or instant type messaging content. In this manner, a mobile terminal can benefit from cost and/or quality advantages that may be associated with routing the communications through the local network versus long-range communications.

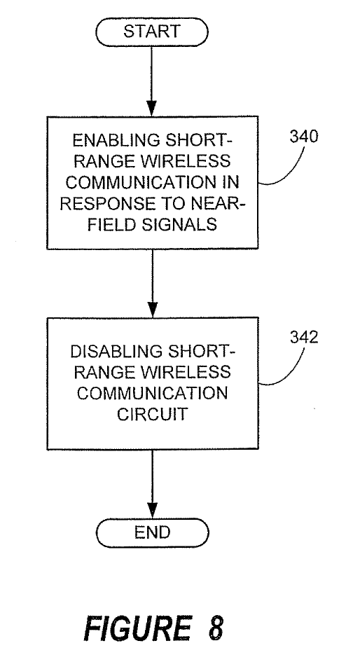

Reference is now made to FIG. 8, which is a flow diagram illustrating further embodiments of operations in accordance with the invention. Short-range wireless communication between a mobile terminal and a network is enabled responsive to near-field signals received by the mobile terminal (block 340). A short-range wireless communication circuit can be disabled when a mobile terminal user terminates access to a short-range wireless access point (block 342). The disabling can be responsive to an NFC performed as the user exits the coverage zone of the network. In some embodiments, the disabling can be responsive to a loss of short-range communication that may occur when the mobile terminal leaves the coverage area of a network short-range transceiver. By disabling the short-range communication circuit in this manner, the mobile terminal can have an increased number of hours of battery life between charges.

In some embodiments, the short-range communication can be updated to a different short-range transceiver that may be part of the same or a different network. This can occur when a user enables the new short-range wireless connection by accessing a network NFC transceiver. In some embodiments, the short-range communication can be transferred to different short-range transceivers within the same network without accessing another network NFC transceiver. For example, the enabling performed using an NFC (block 340) can include exchanging data that includes network short-range transceiver address information for several and/or all of the available short-range transceivers in the network.

As will be appreciated by one of skill in the art, the present invention may be embodied as a method, circuit or communication system. Accordingly, the present invention may take the form of an entirely hardware embodiment, an entirely software embodiment or an embodiment combining software and hardware aspects, all generally referred to herein as a “circuit.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described above with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method for managing mobile communications in a mobile terminal, comprising:
communicating access data from a local area network (LAN) to the mobile terminal through a near-field-communication (NFC) link;
initiating a short-range communication link from the mobile terminal in response to the receipt of the access data by the mobile terminal; and
transmitting routing data, responsive to the short-range communication link, from the mobile terminal to a telecommunication network to cause the telecommunication network to route communications through the short-range communication link.

2. The method of claim 1, wherein transmitting routing data comprises sending the routing data through the short-range communication link.

3. The method of claim 1, wherein transmitting routing data comprises sending the routing data using the near-field communication operation.

4. The method of claim 1, wherein transmitting routing data comprises sending the routing data to a cellular network through a cellular communication link.

5. The method of claim 1, wherein communicating access data comprises receiving into the mobile terminal a network address of a short-range network device.

6. The method of claim 1, wherein initiating a short-range communication link comprises powering-on a short-range transceiver in the mobile terminal.

7. The method of claim 1, wherein initiating a short-range communication link comprises transmitting access payment information from the mobile terminal through the short-range communication link to a LAN operator to obtain further access to the short-range communication link.

8. The method of claim 1, wherein initiating a short-range communication link comprises transmitting access payment information from the mobile terminal through the near-field-communication link to a LAN operator to obtain access to the short-range communication link.

9. A system for managing mobile communications, comprising:
a first network transceiver in a local-area-network (LAN) configured to transmit access data through a close-range communication link;
a dual-mode mobile terminal comprising a first mobile transceiver configured to receive the access data through the close-range communication link and a second mobile transceiver configured to communicate LAN access data through a short-range communication link in response to the receipt of the access data; and
a second network transceiver in the LAN configured to receive the LAN access data through the short-range communication link from the second mobile transceiver.

10. The system of claim 9, wherein the first network transceiver is further configured to receive mobile terminal data from the first mobile transceiver and send the mobile terminal data to a communications network and wherein the close-range communication link comprises a near-field-communication link.

11. The system of claim 9, wherein the mobile terminal further comprises a third mobile transceiver configured to communicate with a telecommunication network through a remote transceiver.

12. The system of claim 9, wherein the mobile terminal comprises a client of the LAN and the access data comprises authentication data, wherein the first mobile transceiver receives location data from the first network transceiver over the close-range communication link, and wherein the communication network is configured to allocate network resources responsive to the location data.

13. The system of claim 9, further comprising updating means for providing updated access data when a subsequent close-range communication operation occurs at a third network transceiver in the LAN.

14. A method of managing mobile communications for a multiple mode mobile terminal, comprising:
enabling short-range wireless communication between the mobile terminal and a network in response to near-field signals received by the mobile terminal from a near-field-communication transmitter.

15. The method of claim 14, wherein enabling short-range wireless communication comprises receiving, into the mobile terminal from the near-field communication transmitter, access data corresponding to the network.

16. The method of claim 14, wherein enabling short-range wireless communication comprises sending incoming call routing data from the mobile terminal to a communications system routing device responsive to cause communications to the mobile terminal to be routed using a short-range wireless communication link between the network and the mobile terminal.

17. The method of claim 16, wherein sending incoming call routing data comprises communicating via a cellular communication transceiver in the mobile terminal.

18. The method of claim 14, further comprising sending payment information from the mobile terminal to the network.

19. The method of claim 14, further comprising transmitting, using cellular communication, a routing identifier to a communication system responsive to cause communications to the mobile terminal to be rerouted through the short-range wireless communication link.

20. The method of claim 14, further comprising disabling a short-range wireless communication circuit in the mobile terminal responsive to receipt of a near-field termination signal.

21. The method of claim 14, further comprising sending mobile terminal data to the communication network via through a network near-field communication device.

22. The method of claim 14, further comprising authenticating a mobile client responsive to the near-field signals.

23. The method of claim 22, further comprising:
determining a location of the mobile client using the near-field signals; and
assigning a network resource to the mobile client based on the location.

24. A mobile communication device comprising:
a close-range communications transceiver configured to receive a close-range communication signal from a network; and
a short-range wireless communications transceiver configured to be enabled to communicate with the network responsive to the received close-range communication signals.

25. The device of claim 24, wherein the close-range communications transceiver comprises a signal receiver configured to receive the close-range communication signal via magnetic induction.

26. The device of claim 24, wherein the close-range communication signal comprises a near-field-communication signal.

27. The device of claim 24, wherein the close-range communication signal comprises close-range communication access data corresponding to the network.

28. The device of claim 24, wherein payment data is transferred from the mobile terminal to the network.

29. The device of claim 24, wherein the close-range communications transceiver is configured to receive a disable signal from the network and wherein the short-range wireless communications transceiver is disabled responsive to the disable signal.

30. The device of claim 24, further comprising a cellular transceiver configured to change enablement states responsive to the close-range communication signal.
